(19) United States
(12) Patent Application Publication
(10) Pub. No.: US 2002/0103692 A1
(43) Pub. Date: Aug. 1, 2002

(54) Method and system for adaptive product recommendations based on multiple rating scales

(76) Inventors: Sandra H. Rosenberg, San Jose, CA (US); David Hackson, Sunnyvale, CA (US); Christopher D. Williams, San Jose, CA (US)

Correspondence Address: PILLSBURY WINTHROP, LLP, P.O. BOX 10500, MCLEAN, VA, 22102, US

(21) Appl. No.: 09/749,746

(22) Filed: Dec. 28, 2000

(51) Int. Cl. G06F 17/60

(52) U.S. Cl. 705/10; 705/26

(57) ABSTRACT

An arrangement is provided for enabling adaptive product recommendations based on multiple rating scales. Users' feedback on recommended products is acquired in the form of post-use multiple-scale ratings. A multiple-scale rating comprises a plurality of rating scores with respect to a plurality of rating scales. Each post-use multiple-scale rating is obtained with respect to one product and each product is rated, a priori, by a multiple-scale product rating. Acquired post-use multiple-scale ratings are analyzed. The results of such analysis are used to make future product recommendations adaptive.

### BACKGROUND OF THE INVENTION

1.Field of the Invention

The present invention relates in general to e-commerce. More specifically, it relates to an arrangement that recommends products to users by matching specified properties of products, indicated by users as being desirable, with the properties of available products.

2.General Background and Related Art

E-commerce via the Internet is becoming ubiquitous. More and more business transactions are conducted directly on the web. Individual shoppers are switching on-line shopping at a rapid rate. A user can browse the web site of a particular manufacturer for available products and make purchases if satisfactory products are identified. A user can also browse the web sites of on-line shopping service providers that consolidate products from different manufacturers and make them available for purchase via a single web site. In this latter case, a user is able to browse much larger variety of products with usually a bigger selection pool and price variations for individual types of products.

One factor associated with the service quality of on-line shopping is how efficiently a shopper can make a selection of a desired product. This is particularly crucial for web sites that provide a large variety of products. While it may be beneficial for a user to be offered a big selection of products, the burden on the user to make a selection is increased. Various e-commerce systems deploy automated product recommendation systems to help a shopper to make a product selection more efficiently.

In a product recommendation system, products may be characterized as to one or more attributes. The characterization of products can be utilized to help users to make product selections. For example, books may be classified into various categories according to the subject of the book. For instance, a book may be characterized as a history (a category) book. By acquiring a user's specification (or characterization) about his/her desired book in terms of known book categories, a list of books may be identified that fit the user's characterization of the desired product. This list of books forms a product recommendation that is consistent with the user's desires. Equally importantly, the recommendation substantially reduces the selection pool so that the user can make a final choice based on a smaller amount of, yet more relevant information.

Existing product recommendation systems use overall rating information to characterize a product. For example, a product may be associated with a score that reflects the popularity of the product, measured by, for instance, how many people have purchased the product. In such a measure, a user's purchasing of a product is equated with the user's liking of the product. This may not be necessarily true, though. So, such overall rating information does not reflect the feedback from product users.

In addition, such overall rating information is one-dimensional. An overall rating may be indicative in a general sense, but it offers no specifics about, for example, what aspects of a product lead to a low or high rating, which can be very useful information to a shopper. For example, if a movie is rated very popular, there is no way of knowing, from an overall popularity score, whether the popularity is due to the actions in the movie or due to the artistry of the movie.

There is a need for a product recommendation system that recommends products according to product characterizations using multiple rating scales and that adapts by self-calibrating the system based on users' feedback acquired from product users.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 shows a high level block diagram of an illustrated embodiment of the present invention;

FIG. 2 is an exemplary flowchart of a process for recommending a product with self-calibrating capability;

FIG. 3 shows an exemplary rating scale;

FIG. 4 shows an exemplary rating on multiple scales;

FIG. 5 shows an exemplary flowchart of a process for acquiring post-use multiple-scale ratings across a set of products;

FIG. 6 shows an exemplary expanded functional block diagram of an embodiment of the present invention;

FIG. 7 shows an example, in which a rating score with respect to a particular rating scale is calibrated based on post-use ratings from users;

FIG. 8 shows an exemplary flowchart of a process for updating a multiple-scale rating of a product based on post-use ratings from users;

FIG. 9 shows an example, in which a personalized filter is generated based on the discrepancy between a user's pre-use product selection specifications of desired products and the user's post-use ratings on the recommended products;

FIG. 10 shows an exemplary flowchart of a process for generating a personalized multiple-scale filter;

FIG. 11 shows an example, in which causes of users' dissatisfaction are identified based on post-use multiple-scale ratings; and

FIG. 12 shows an exemplary flowchart of a process for generating an adjustment filter used to adjust the importance of rating scales.

### DETAILED DESCRIPTION

An embodiment of the invention is described with reference to the drawings to improve upon known product recommendation arrangements by enabling product recommendations based on adaptive multiple-scale ratings. The illustrated embodiment allows a product recommendation system to self-calibrate multiple-scale ratings according to post-use multiple-scale ratings from users of the recommended products.

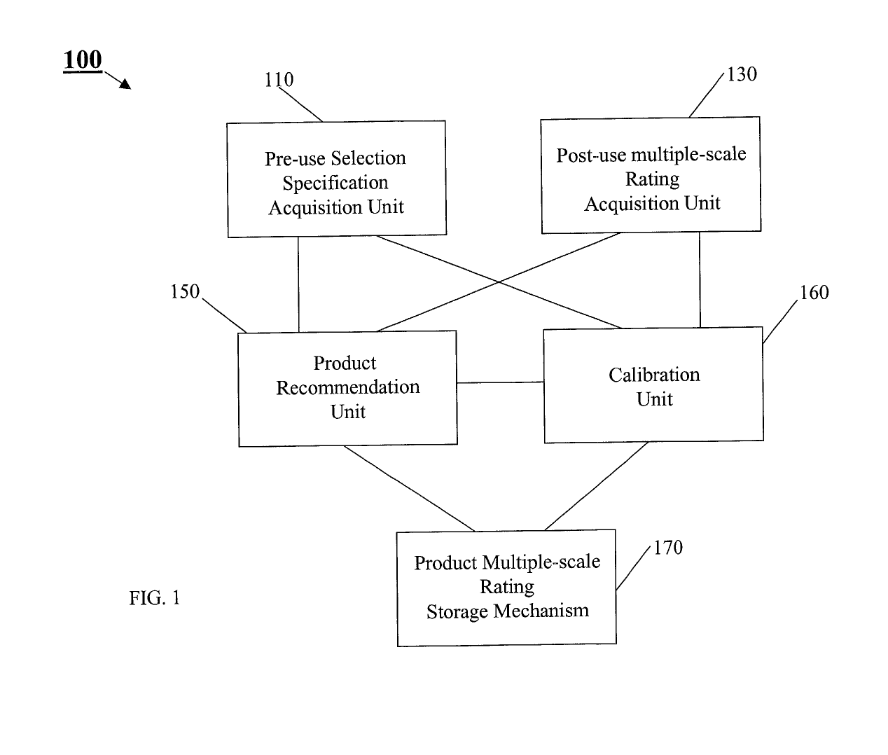

FIG. 1 is a high level block diagram of a multiple-rating-scale based product recommendation system 100. The illustrated product recommendation system 100 comprises a pre-use product selection specification acquisition unit 110, a post-use multiple-scale rating acquisition unit 130, a product recommendation unit 150, a calibration unit 160, and a product multiple-scale rating storage mechanism 170.

In FIG. 1, pre-use product selection specification acquisition unit 110 acquires a user's input, prior to making a product recommendation. The user's input specifies the properties of the product that the user desires. In a product recommendation system, products may be rated according to some criteria. Such rating information is stored in product multiple-scale rating storage mechanism 170 and is accessible to product recommendation unit 150. A pre-use product selection specification may be constructed with respect to the rating scales used in product ratings so that the selection specification can be used to match with corresponding product ratings to select the products whose ratings are similar to what a user desires.

In the illustrated embodiment of the present invention shown in FIG. 1, the rating for each product is multiple-scaled and may be represented as a set of scores or a vector. Storage mechanism 170 is capable of storing, randomly access or retrieving multiple-scale rating information.

Product recommendation unit 150 makes product recommendations to a user based on the pre-use product selection specifications, acquired from the user, and current multiple-scale rating information of products, retrieved from product multiple-scale rating storage mechanism 170.

In the illustrated embodiment of the present invention, users' feedback on the recommended products may be acquired after the recommended products have been tried. Such feedback is obtained in the form of post-use ratings that may also be multiple-scaled. The scales used in post-use ratings may correspond to the scales used in current product ratings. The post-use ratings may be utilized to re-calibrate current product ratings. In FIG. 1, post-use multiple-scale rating acquisition unit 130 acquires post-use multiple-scale ratings from users. The post-use multiple-scale ratings are fed to calibration unit 160 to re-calibrate the current multiple-scale product ratings, Calibration unit 160 may also use pre-use selection specifications for calibration purposes. The calibrated results may be saved in product multiple-scale rating storage mechanism 170.

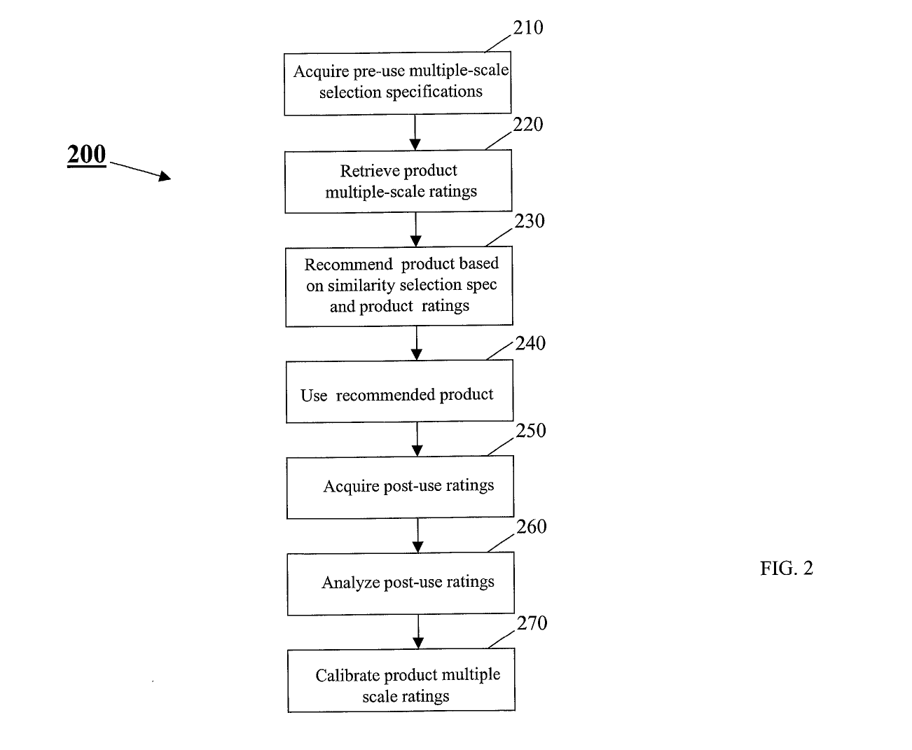

FIG. 2 is an exemplary flowchart for system 100. A pre-use multiple-scale selection specification is first acquired from a user at act 210. Pre-use refers to the fact that the specification is given prior to the use of a product. A pre-use selection specification defines the properties of a desired product. For example, a user may indicate, through a pre-use selection specification, that the desired product has an overall rating above 7, out of a scale from 1 to 10.A multiple-scale selection specification defines more than one property of the desired product. For example, a user may look for a desired movie (a product) in terms of amount of action in the movie, whether it is a drama (as opposed to comedy movie), and the overall rating of the movie.

Once a pre-use product selection specification is acquired, current product rating information is retrieved at act 220 from product multiple-scale rating storage mechanism 170. Based on both the pre-use product selection specification, acquired at act 210, and the current product multiple-scale rating information, retrieved at act 220, product recommendation unit 150 makes a product recommendation at act 230 by selecting one or more products whose multiple-scale ratings are substantially similar to the pre-use product selection specification. The recommended products are used or tried at act 240 by the user. After the use of the recommended products, post-use multiple-scale rating acquisition unit 130 acquires feedback at act 250 from the user. A post-use multiple-scale rating may include rating scales that correspond to the rating scales used in current rating for products. Based on post-use multiple-scale ratings, calibration unit 160 performs various analyses at act 260. Such analyses may be carried out in relation to the corresponding pre-use selection specifications. Calibration unit 160 further performs calibration of current multiple-scale product ratings at act 270.

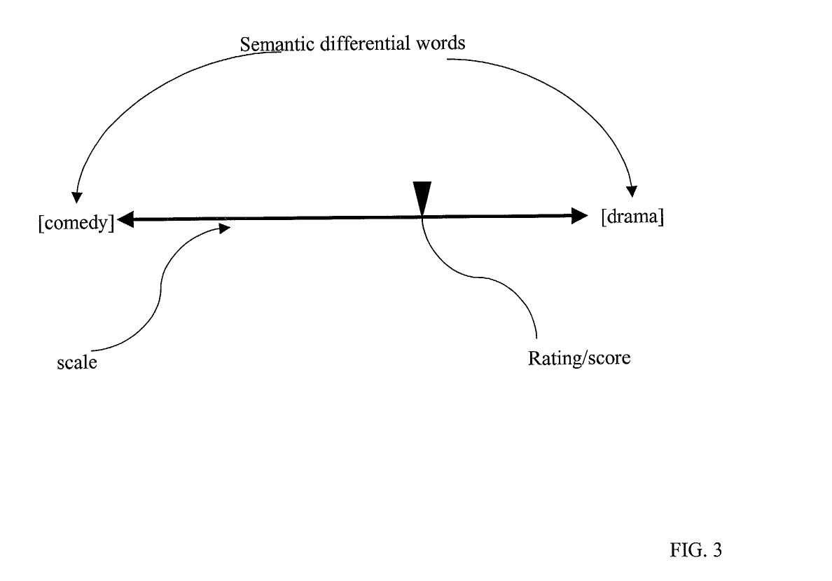

Each scale used in a multiple-scale rating may correspond to a specific product property. The rating with respect to a specific scale or product property may be specified as a score within a certain range. Such a range may be defined by two numerals or by two semantic differential words. FIG. 3 shows an exemplary rating scale with a range defined by two semantic differential words. The scale shown in FIG. 3 applies to movie products and the two semantic differential words are comedy and drama, that define the two extremes on the scale. A movie can be rated on this particular scale through a rating score. The rating score on a scale may be determined, as illustrated in FIG. 3, by the position of a slider on the scale. When the two semantic differential words of a range are translated into numerals, any position within the range may be translated into a numerical score.

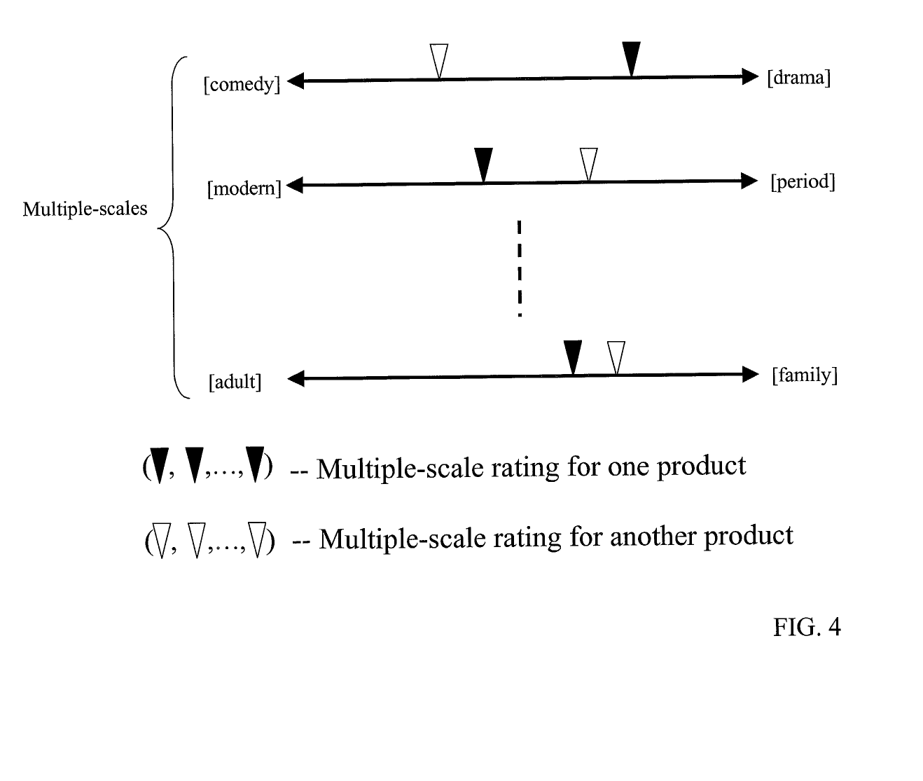

In a multiple-scale rating scheme, each product is rated with respect to a plurality of scales. FIG. 4 shows an exemplary multiple-scale rating for movie products. In FIG. 4, top scale is formed by semantic differential words comedy and drama, next scale is formed by semantic differential words modern and period, and the bottom scale is formed by semantic differential words adult and family. Each product is rated on every scale and the ratings from all the scales form a multiple-scale rating of that product. For example, in FIG. 4, all the solid (black) slider positions form a multiple-scale rating for a particular movie. The hollow slider positions correspond to a multiple-scale rating for a different movie.

When acquiring a pre-use selection specification, pre-use selection specification acquisition unit 110 may present multiple scales to a user and let the user to determine a slider position on each scale. The acquired set of slider positions forms a multiple-scale selection specification which can be used to compare with the slider positions or multiple-scale ratings of various products to select a product that has the closest slider positions to what the user specified.

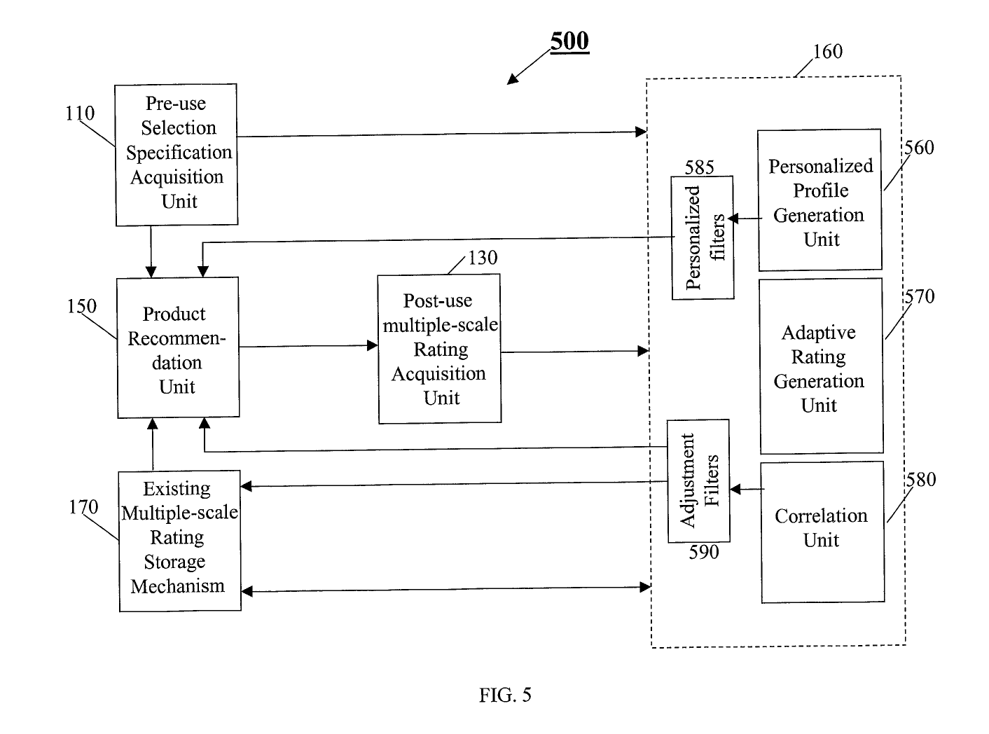

FIG. 5 presents an exemplary expanded functional block diagram of system 100. In FIG. 5, product recommendation unit 150 selects a product for recommendation according to both a pre-use selection specification, acquired by pre-use product selection specification acquisition unit 110, and current multiple-scale ratings of products, retrieved from product multiple-scale rating storage mechanism 170. A recommendation product may be selected by maximizing the proximity between a pre-use selection specification and a current product rating. In doing so, the selected product best fits the properties of the desired product.

Once a recommended product is tried by a user, post-use multiple-scale rating acquisition unit 130 acquires feedback from the user by collecting post-use ratings with respect to various rating scales. It should be noted that post-use ratings may also be independently acquired without the prior product recommendation and use stages. For example, a on-line shopping service provider may simply conduct a survey on all the movie products from volunteers on the web.

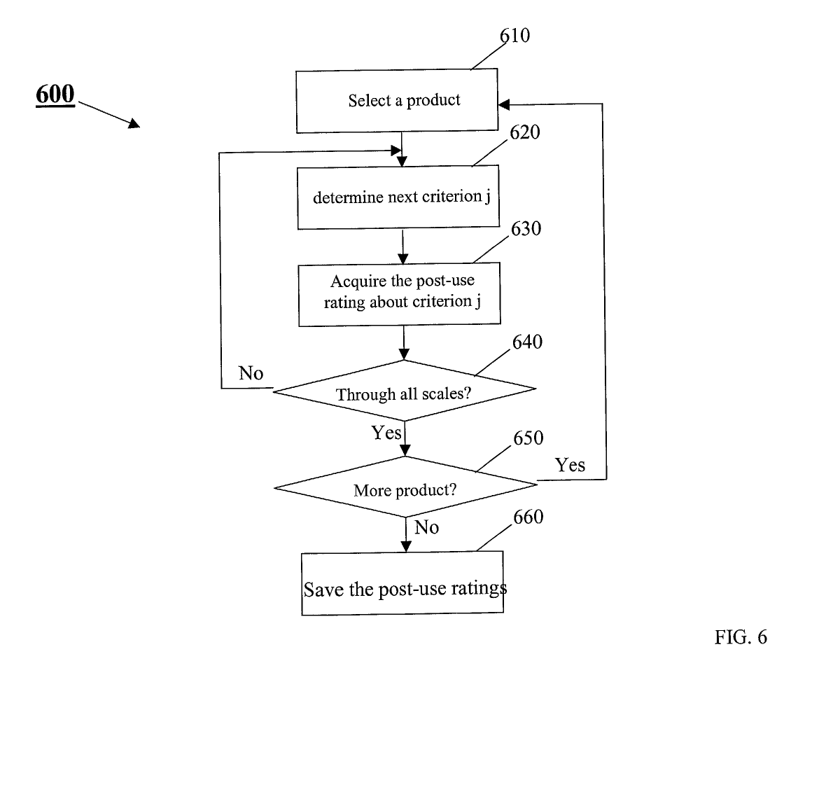

FIG. 6 presents an exemplary flowchart for a process that acquires post-use multiple-scale ratings. In FIG. 6, a product is identified at act 610 for which the post-use feedback is to be acquired. For each identified product, post-use ratings on multiple scales may be collected one by one through the loop from act 620 to act 660. A rating scale in each loop is determined at act 620 and the post-use rating on the scale is acquired at act 630. The loop continues until the ratings across all the scales are collected. This is determined at act 640. The acquisition process shown in FIG. 6 also allow collecting post-use multiple-scale ratings across different products. Whether proceeding to a different product is determined at act 650. The acquired post-use multiple-scale ratings are saved at act 660 in post-use multiple-scale rating acquisition unit 130.

In the illustrated system, shown in FIG. 5, acquired post-use multiple-scale ratings may be fed to calibration unit 160 for calibration purposes. There may be various ways to utilize the post-use multiple-scale ratings collected from users. For example, post-use ratings may be used to simply understand the service quality of a product recommendation system. Various statistics may be extracted from post-use ratings to characterize degree of satisfaction of users. It is also possible to use post-use ratings, as feedback, to re-calibrate product recommendation system 100 so that the service quality can be improved.

Post-use multiple-scale ratings from different individuals may be utilized to establish personalized profiles so that product recommendation may be carried out in an individualized manner to improve the service quality. Personalized profiles may include the information about personal taste and may be used to construct individual filters that may be used, by system 100, during recommending products to corresponding individuals so that the products can be selected according to personal taste.

Another example of using post-use multiple-scale ratings is to adapt the product ratings currently employed by system 100 based on post-use ratings. For example, a current product rating may be updated according to the average post-use rating for the same product so that the new product rating is better tuned to the public perception of the product.

Yet one more example of utilizing post-use multiple-scale ratings is to adaptively adjust the decision making strategy of system 100 in selecting recommendation products. For example, according to users' feedback (post-use ratings), some of the rating scales (i.e., product properties) may seem more important to users or have bigger impact on users' satisfaction. Such rating scales may be detected by correlating post-use ratings in different scales with a satisfaction rating, also collected from users. In this case, it may be useful for system 100 to adopt a variable weighting scheme in product selection. That is, some of the ratings are treated more important than others.

In FIG. 5, calibration unit 160 may comprise, but is not limited to, three components: personalized profile generation unit 560, adaptive rating generation unit 570, and correlation unit 580.

Personalized profile generation unit 560 takes both pre-use selection specifications and the corresponding post-use multiple-scale ratings from a user to establish a personalized profile for the user. A personalized profile may be constructed based on personal taste which may be identified by recognizing the pattern in which pre-use selection specifications differ from post-use ratings. Such a pattern may be recognized by observing the discrepancy between what a user desires and what the user thinks what he/she gets across a plurality of products.

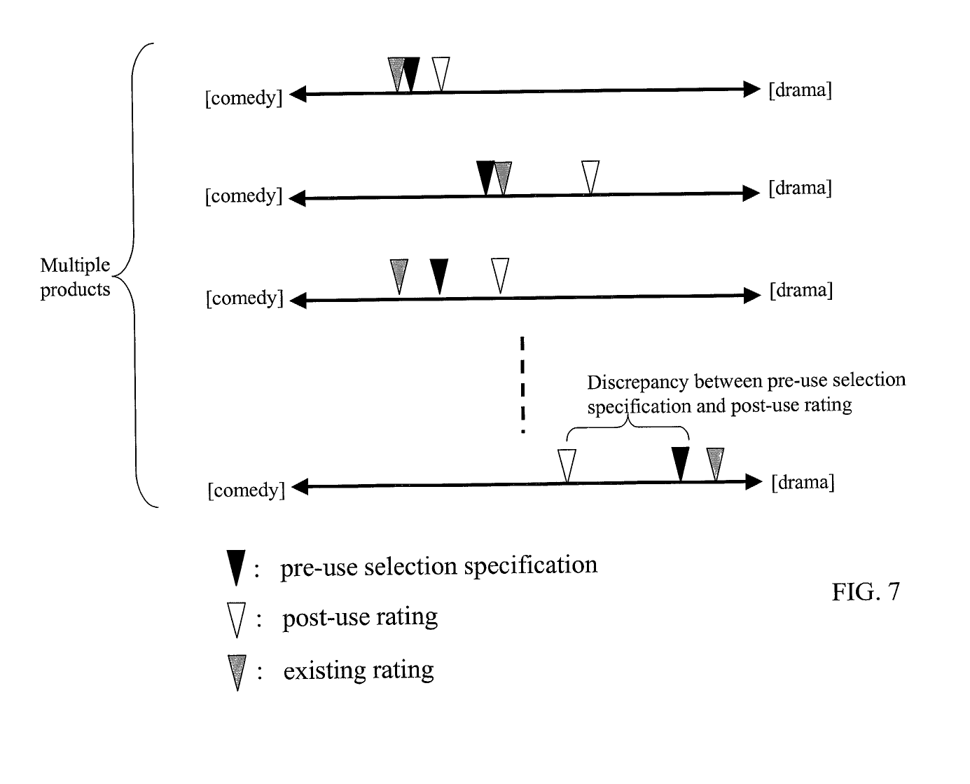

FIG. 7 illustrates an example of how personal taste with respect to a particular rating scale may be identified using post-use ratings. There are a set of scales illustrated in FIG. 7, each of which corresponds to one movie (product). . The exemplary scale in FIG. 7 applies to movie products and is formed by two semantic differential words, comedy and drama. On each scale, there are three sets of ratings (solid, hollow, and gray). A solid slider position represents a pre-use selection specification from a user, a gray slider position represents the current rating for a particular movie, and a hollow slider position represents the post-use multiple-scale rating of the movie from the user. Using the three sets of ratings across different movies, personal taste with respect to the illustrated rating scale can be identified based on the discrepancy between pre-use selection specifications and post-use ratings. The detected taste difference can then be used to calibrate product recommendation at an individual basis.

When the user slides the scale to a solid slider position, it specifies the degree of dramaness (or degree of comedy) of a desired product. Product recommendation system 100 uses such a specification to compare with the current product ratings on the same scale. The movie that has the gray slider position (or rating) closest to the solid slider position is chosen to be the recommendation. After the user reviews the movie, post-use rating is obtained as the hollow slider position on the same scale. A large discrepancy between solid and hollow slider positions indicates that the user may not get what is desired. If such a discrepancy is consistent across different movies, it indicates that there may be a taste difference in this particular user. For example, the post-use ratings in FIG. 7 are consistently to the right of pre-use selection specifications. In this case, the user may be more comedy oriented (i.e., the user considers more movies as drama than what the product ratings indicate

When a taste difference is identified, a personalized profile may be established that characterizes the personal taste of a particular user in terms of how it deviates from current ratings. A personalized profile for a particular user may be utilized to construct a filter to be used by product recommendation system 100 to accordingly adjust future product recommendations for this particular user on an individual basis.

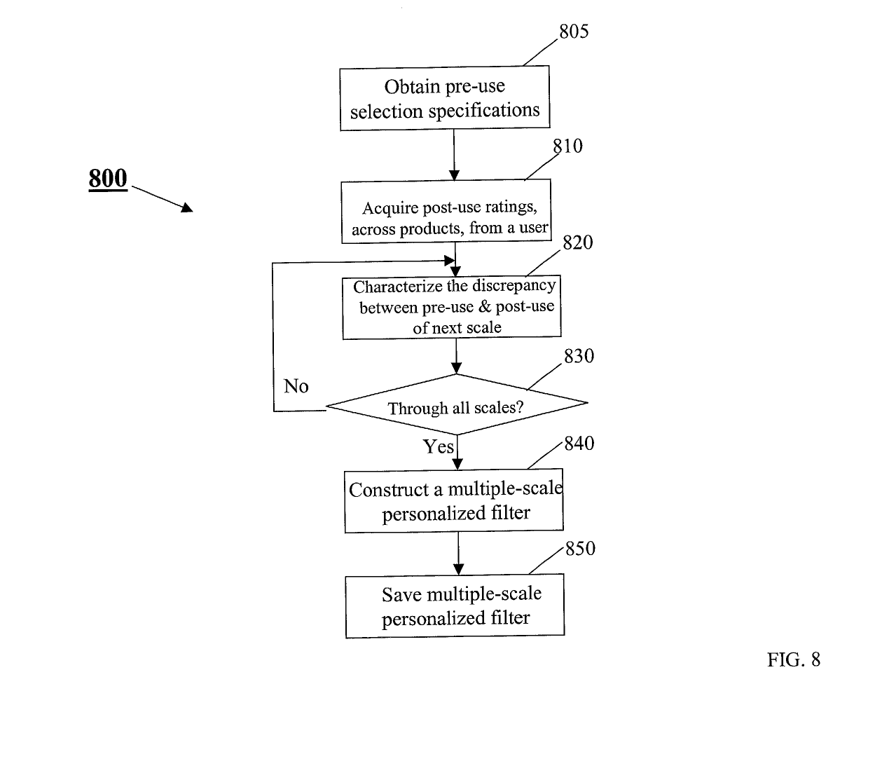

FIG. 8 shows an exemplary flowchart for personalized profile generation unit 560. To detect taste difference, pre-use selection specifications and post-use multiple-scale ratings across a set of products are collected at acts 805 and 810. The difference between pre-use product selection specifications and post-use ratings with respect to each scale is characterized at act 820 and act 830. Such difference may be characterized in different ways. For example, the differences on a particular scale across various products may be used to form a difference vector. Alternatively, the differences on a particular scale across products may be used to obtain a mean difference. Another example is to compute a median difference.

Characterization of the discrepancy between pre-use selection specifications and post-use multiple-scale ratings aims at describing the taste difference between a particular user and current product ratings. The discrepancy characterization is used to build a personalized filter at act 840. Such personalized profile is saved at act 850, together with other personalized filters 585 (FIG. 5), so that product recommendation system 100 may use it to individualize future recommendations for the corresponding user.

A different self-calibration functionality of system 100 may be to use post-use multiple-scale ratings to calibrate current product ratings. Current product ratings may be based on professional assessment of products, such as movie critics, or popular views, such as movie reviews from audience. Such ratings may change with time due to different reasons.

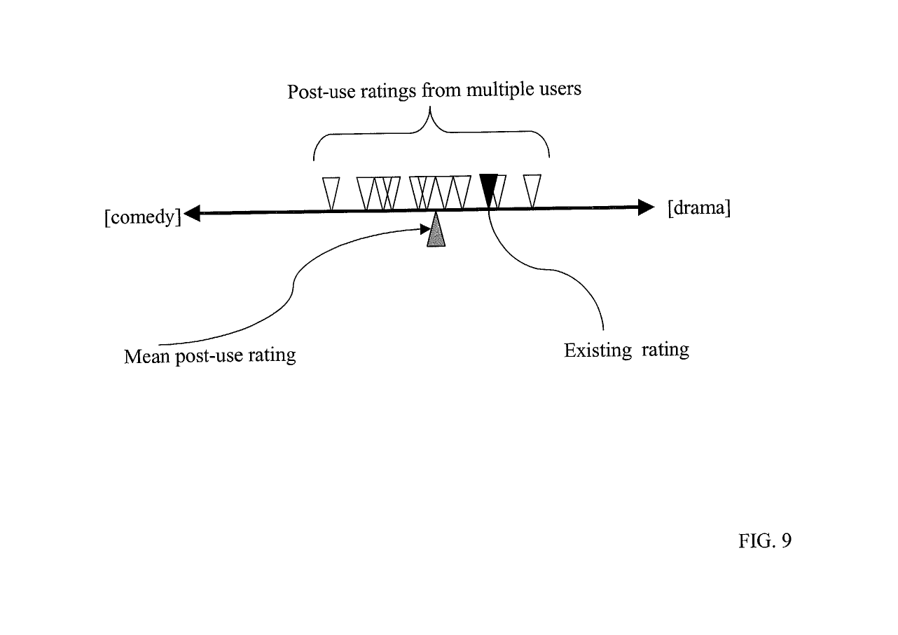

Recommendation quality may be affected by how closely the current ratings are consistent with users' views. Poor quality in recommending products causes users' dissatisfaction and may be reflected in post-use ratings. If quality degradation is due to difference in personal taste, service quality may be improved by applying personalized filters during product recommendation, as described earlier. When quality degradation is due to changes in public perception about products, current ratings may need to adapt to such changes. This is achieved, in FIG. 5, by adaptive rating generation unit 570. FIG. 9 shows an example of how post-use ratings from multiple users may be used to calibrate a current rating.

In FIG. 9, the solid slider position represents a current rating of a movie on a scale formed by semantic differential words comedy and drama. The hollow slider positions represent post-use ratings on the same movie from multiple users. When a substantial number of users produce post-use ratings that are significantly deviated from the current rating, it may indicate that the current rating needs to be re-calibrated. An adjustment to the current rating may be derived from the post-use ratings. For example, a mean post-use rating may be computed from the post-use ratings. This is illustrated in FIG. 9, in which the gray slider position represents the mean post-use rating on the scale of comedy vs. drama. This mean post-use rating may be used directly to replace the current rating or to be combined with the current rating to derive an adjusted rating. A multiple-scale rating may be re-calibrated by individually adjust the rating of each and every scale.

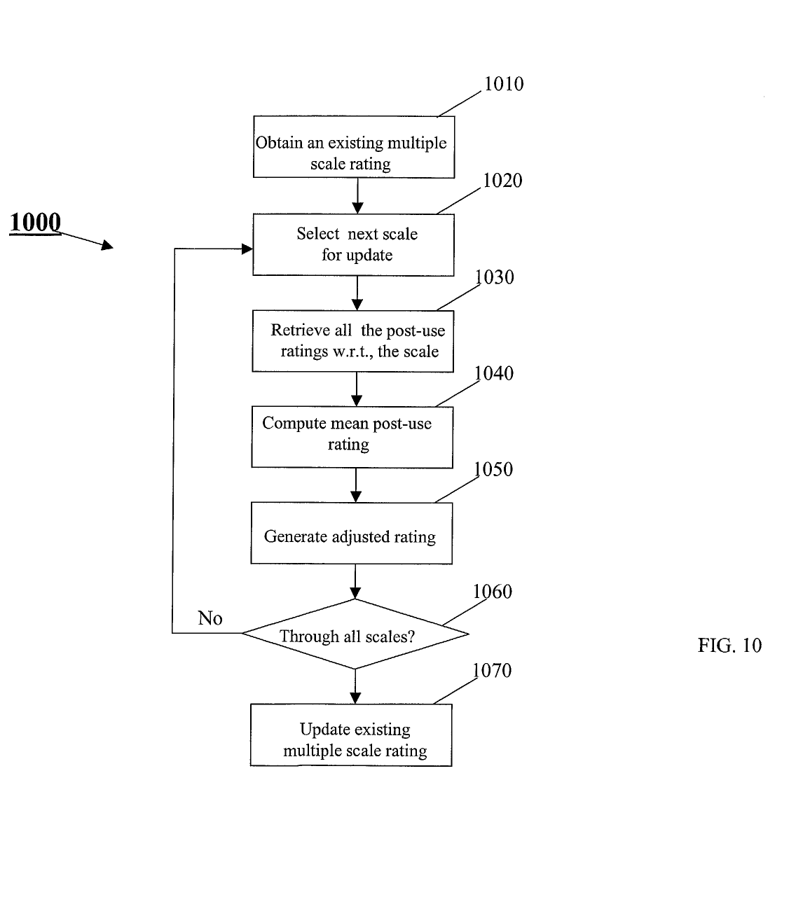

FIG. 10 presents an exemplary flowchart of adaptive rating generation unit 570. A current multiple-scale rating for a product is obtained at act 1010 from product multiple-scale rating storage mechanism 170. Within the loops from act 1020 to act 1060 in FIG. 10, the current multiple-scale rating is re-calibrated, one scale in each loop. At act 1020, next scale to be calibrated is selected as current scale. The post-use ratings with respect to the current scale from multiple users are retrieved at act 1030. These post-use ratings are used to derive a mean post-use rating at act 1040. An adjusted rating with respect to the current scale is obtained at act 1050 by re-calibrating corresponding current rating using the mean post-use rating. The adjusted ratings of all scales form an adjusted multiple-scale rating which is used, at act 1070, to update the product rating in product multiple-scale rating storage mechanism 170. With current multiple-scale product ratings re-calibrated, future product recommendations may be made based on a multiple-scale rating that better fits with what users perceive. The service quality may subsequently improve.

When a product is recommended to a user, the acceptance of the recommended product does not necessarily imply satisfaction. That is, a user may use a recommended product but may not be satisfied with the product. The dissatisfaction may not be caused by personal taste difference or out-of-date multiple-scale ratings. It is often desirable to identify exactly what attributes to users' disliking of recommended products.

Identifying the factors that attribute to users' dissatisfaction is different from detecting the difference in personal taste or detecting the inconsistency between current ratings and users' perception. Whether a user is satisfied or dissatisfied with a recommended product may be viewed as an overall rating on the recommendation itself. The scale associated with such an overall rating may be described by semantic differential words “dislike” and “like”. A rating on this scale is also a post-use feedback. It should be noted that this post-use overall rating is not rated on products, as in the case of other scales described earlier, but rather on the recommendation.

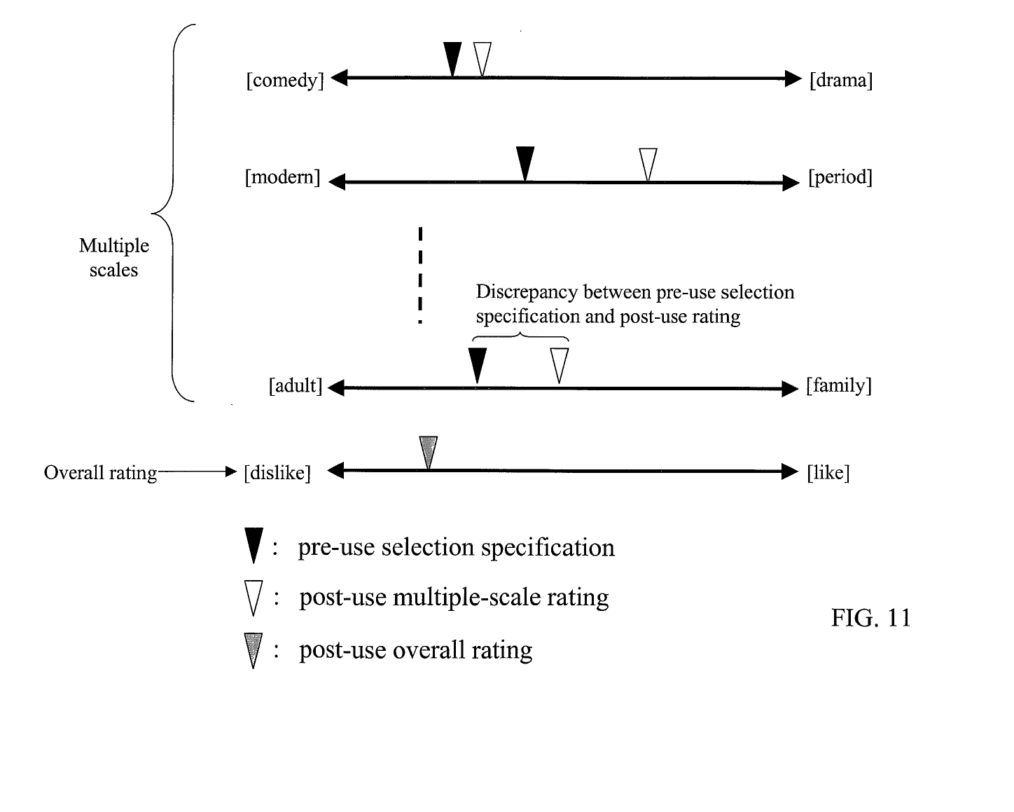

To identify the cause of users' dissatisfaction may involve identifying the relationship between an overall degree of satisfaction (an overall rating) and various scales on which a product is rated. In other words, it is to identify which scales or which corresponding product properties drive users' dissatisfaction. In the illustrated embodiment shown in FIG. 5, correlation unit 580 identifies the product properties that attribute to users' dissatisfaction. Correlation unit 580 combines users' post-use overall ratings, with respect to the rating scale of dislike vs. like, and users' post-use multiple-scale ratings to perform self-calibration. FIG. 11 shows an exemplary relationship between post-use multiple-scale ratings and post-use overall dislike-like rating.

In FIG. 11, a plurality of post-use rating scales for movie products are shown, together with an additional overall rating scale. The example rating scales for movies are comedy vs. drama, modem vs. period, and adult vs. family. The overall rating scale is characterized by semantic differential words dislike and like. In FIG. 11, solid slider positions represent pre-use selection specifications and hollow slider positions represent post-use ratings. The gray slider position on the overall rating scale represents a post-use overall rating.

The discrepancy between a pre-use selection specification and corresponding post-use rating on a particular scale may be correlated with the overall rating. If a large discrepancy on a particular scale, for example on scale modem vs. period, consistently co-occurs with a low overall rating (dislike), it may indicate that the corresponding product property, associated with the scale of modem vs. period, may be an attributer to users' dissatisfaction.

Analyses, such as regression, may be performed to identify the rating scales or product properties that drive dissatisfaction. The product properties that are identified as driving factors of dissatisfaction may be accordingly re-calibrated. For example, system 100 may adopt a product recommendation strategy, in which rating on individual scales are weighted and the weights associated with the scales identified as driving factors to dissatisfaction may be weighted higher. In doing so, the product recommendation system may be able to make recommendations that are more sensitive to those attributing scales. Such weights may be derived from analyzing the discrepancies between pre-use and post-use ratings, in relation to the overall ratings.

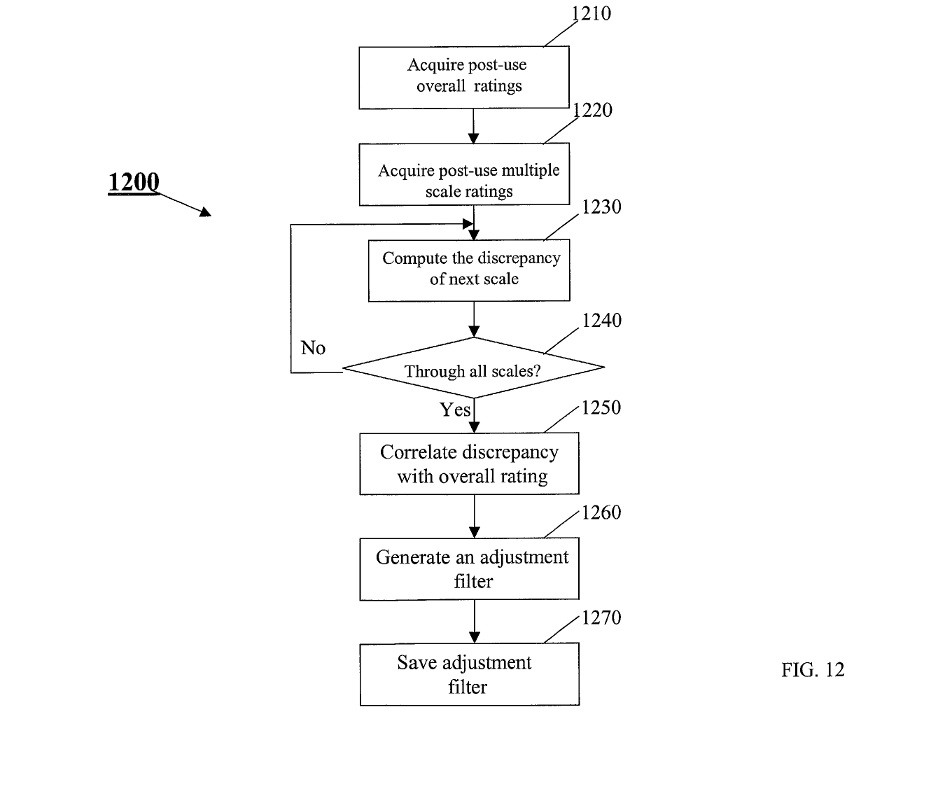

FIG. 12 shows an exemplary flowchart of correlation unit 580. Post-use overall ratings are acquired from users across products at act 1210. Corresponding post-use multiple-scale ratings are acquired at act 1220. Discrepancies between pre-use product selection specification and post-use ratings on every scale from every user are computed within the loops from act 1230 to act 1240. Such computed discrepancies are analyzed, in relation to the overall ratings, at act 1250, to identify the rating scales (corresponding to certain product properties) that significantly attribute to users' dissatisfaction. Based on to such identified causes, an adjustment filter is built at act 1260 and saved, at act 1270, in adjustment filters 590.

An adjusted filter may be implemented as, but not limited to, a set of weights associated with multiple rating scales. As illustrated in FIG. 5., adjustment filters may be used either to update current product ratings by applying the weights to individual scales (the link from 590 to 170) or to be incorporated by product recommendation unit 150 in product selection process (the link from 590 to 150) so that future product recommendation decisions can be made accordingly to minimize users' dissatisfaction.

The processing described above may be performed by a general-purpose computer alone or in connection with a specialized graphical processing computer. Such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

What is claimed is:

1. A method for enabling adaptive product recommendations based on multiple-scale ratings, said method comprising:
acquiring post-use multiple-scale ratings from at least one user, said post-use multiple-scale ratings corresponding to at least one product, said at least one product being rated by multiple-scale product ratings, each of said post-use multiple-scale ratings and each of said multiple-scale product ratings comprising a plurality of rating scores with respect to a plurality of rating scales;
analyzing said post-use multiple-scale ratings; and
enabling adaptive product recommendations based on the analysis resulted from said analyzing.

2. The method according to claim 1, wherein said enabling includes at least one of:
updating said multiple-scale product ratings using a new multiple-scale rating generated based on the analysis resulted from said analyzing;
generating at least one multiple-scale personalized filter for said at least one user to filter said multiple-scale product ratings on an individual basis; and
identifying zero or more said rating scales that correlate with dissatisfaction of said users to adjust the importance of each of said rating scales in said multiple-scale product ratings.

3. A method for adjusting a multiple-scale product rating based on post-use multiple-scale ratings, said method comprising:
obtaining a multiple-scale product rating of a product, said multiple-scale product rating comprising a plurality of rating scores with respect to said rating scales;
acquiring post-use multiple-scale ratings of said product from a plurality of users of said product, each of said post-use multiple-scale ratings comprising a plurality of rating scores with respect to a plurality of rating scales; and
adjusting said multiple-scale product rating based on the post-use multiple-scale ratings.

4. The method of claim 3, wherein said adjusting includes:
generating a new multiple-scale rating based on said post-use multiple-scale ratings; and
revising said multiple-scale product rating of said product based on said new multiple-scale rating.

5. A method for generating a multiple-scale personalized filter, said method comprising:
obtaining a plurality of pre-use multiple-scale selection specifications from a user, each of said pre-use multi-scale selection specifications describing a desired product and comprising a plurality of rating scores with respect to a plurality of rating scales;
obtaining a list of products determined based on said pre-use multiple-scale selection specifications and at least one multiple-scale product rating, each of said at least one multiple-scale product ratings corresponding to one of said products and comprising a plurality of corresponding rating scores with respect to said rating scales; and
acquiring post-use multiple-scale ratings of said products from said user, each of said post-use multiple-scale ratings corresponding to one of said products and comprising a plurality of corresponding rating scores with respect to said rating scales.

6. The method of claim 5, further comprising:
analyzing said pre-use multiple-scale selection specifications and said post-use multiple-scale product ratings to generate a pre/post-use discrepancy; and
generating said multiple-scale personalized filter for said user based on said pre/post-use discrepancy.

7. A method for identifying causes of users' dissatisfaction based on post-use multiple-scale ratings, said method comprising:
obtaining a plurality of pre-use multiple-scale selection specifications from at least one user, each of said pre-use multi-scale selection specifications comprising a plurality of rating scores with respect to a plurality of rating scales;
obtaining a list of products determined based on said pre-use product selection specifications and multiple-scale product ratings, each of said multiple-scale product ratings corresponding to one of said products and comprising a plurality of rating scores with respect to said rating scales; and
acquiring post-use multiple-scale ratings of said products from said at least one user, each of the post-use multiple-scale ratings corresponding to one of said products and comprising a plurality of rating scores with respect to said rating scales.

8. The method of claim 7, further comprising:
acquiring post-use satisfaction ratings of said products from said at least one user of said products;
analyzing said pre-use multiple-scale selection specifications and said post-use multiple-scale ratings to generate a pre/post-use discrepancy; and
correlating the post-use satisfaction ratings with the pre/post-use discrepancy to identify the rating scales whose pre/post-use discrepancies substantially correlate with low values of said post-use satisfaction ratings.

9. A computer-readable medium encoded with a program for enabling adaptive product recommendations based on multiple-scale ratings, said program comprising:
acquiring post-use multiple-scale ratings from at least one user, said post-use multiple-scale ratings corresponding to at least one product, said at least one product being rated by multiple-scale product ratings, each of said post-use multiple-scale ratings and each of said multiple-scale product ratings comprising a plurality of rating scores with respect to a plurality of rating scales;
analyzing said post-use multiple-scale ratings; and
enabling adaptive product recommendations based on the analysis resulted from said analyzing.

10. The computer-readable medium according to claim 9, wherein said enabling includes at least one of:
updating said multiple-scale product ratings using new multiple-scale rating generated based on the analysis resulted from said analyzing;
generating at least one multiple-scale personalized filter to filter said multiple-scale product ratings on an individual basis; and
identifying zero or more said rating scales that correlate with dissatisfaction of said users to adjust the importance of each of said rating scales in said multiple-scale product ratings.

11. A computer-readable medium encoded with a program for adjusting a multiple-scale product rating based on post-use multiple-scale ratings, said program comprising:
obtaining a multiple-scale rating of a product, said multiple-scale product rating comprising a plurality of rating scores with respect to said rating scales;
acquiring post-use multiple-scale ratings of said product from a plurality of users of said product, each of said post-use multiple-scale ratings comprising a plurality of rating scores with respect to a plurality of rating scales; and
adjusting multiple-scale product rating based on post-use multiple-scale ratings.

12. The computer-readable medium according to claim 11, wherein said adjusting includes:
Generating a new multiple-scale rating based on said post-use multiple-scale ratings; and
revising said multiple-scale product rating of said product based on said new multiple-scale rating.

13. A computer-readable medium encoded with a program for generating a multiple-scale personalized filter, said program comprising:
obtaining a plurality of pre-use multiple-scale selection specifications from a user, each of said pre-use multi-scale selection specifications comprising a plurality of rating scores with respect to a plurality of rating scales;
obtaining a list of products determined based on said pre-use multiple-scale selection specifications and at least one multiple-scale product rating, each of said at least one multiple-scale product rating corresponding to one of said products and comprising a plurality of corresponding rating scores with respect to said rating scales; and
acquiring post-use multiple-scale ratings of said products from said user, each of said post-use multiple-scale ratings corresponding to one of said products and comprising a plurality of corresponding rating scores with respect to said criteria.

14. The computer-readable medium of claim 13, said program further comprising:
analyzing said pre-use multiple-scale selection specifications and said post-use multiple-scale product ratings to generate a pre/post-use discrepancy; and
generating said multiple-scale personalized filter for said user based on said pre/post-use discrepancy.

15. A computer-readable medium encoded with a program for identifying causes of users' dissatisfaction based on post-use multiple-scale ratings, said program comprising:
obtaining a plurality of pre-use multiple-scale selection specifications from at least one user, each of said pre-use multi-scale selection specifications comprising a plurality of rating scores with respect to a plurality of rating scales;
obtaining a list of products determined based on the proximity between said pre-use product selection specifications and at least one multiple-scale product rating, each of said multiple-scale product ratings corresponding to one of said products and comprising a plurality of rating scores with respect to said rating scales; and
acquiring post-use multiple-scale ratings of said products from said at least one user, each of the post-use multiple-scale ratings corresponding to one of said products and comprising a plurality of rating scores with respect to said rating scales.

16. The computer-readable medium of claim 15, said program further comprising:
acquiring post-use satisfaction ratings of said products from said at least one user of said products;
analyzing said pre-use multiple-scale selection specifications and said post-use multiple-scale ratings to generate a pre/post-use discrepancy; and
correlating the post-use satisfaction ratings with the pre/post-use discrepancy to identify the rating scales whose pre/post-use discrepancies substantially correlate with low values of said post-use satisfaction ratings.

17. A system for adaptively making product recommendations based on multiple-scale product ratings, said system comprising:
an acquisition unit for acquiring pre-use selection specifications from users, each of said pre-use selection specifications specifying a desired product and comprising a plurality of scores corresponding to a plurality of rating scales;
a product rating storage mechanism for storing multiple-scale product ratings on a plurality of products, each of said multiple-scale product ratings corresponding to one of said products and comprising a plurality of rating scores corresponding to said product rating scales;
a product recommendation unit for making product recommendations based on said pre-use selection specifications and said multiple-scale product ratings; and
an acquisition unit for acquiring post-use multiple-scale ratings from said users, each of said post-use multiple-scale product ratings comprising a plurality of rating scores corresponding to said product rating scales.

18. The system according to claim 17, further comprising:
a calibration unit for enabling adaptive product recommendations based on said post-use multiple-scale ratings.

19. The system according to claim 18, wherein said calibration unit includes at least one of:
a personalized filter generator for generating a personalized filter for one of said users based on said pre-use selection specifications, acquired from said one of said users, and said post-use multiple-scale product ratings, acquired from said one of said users;
an adaptive rating generator for updating multiple-scale product ratings of said products based on said post-use multiple-scale ratings on said products, acquired from said users; and
a correlator for correlating said rating scales based on said pre-use selection specifications and post-use multiple-scale ratings to adjust the importance of said rating scales in said multiple-scale product ratings.
